(19) United States
(12) Patent Application Publication
(10) Pub. No.: US 2022/0244146 A1
(43) Pub. Date: Aug. 4, 2022

(54) A HUMIDITY DETECTION EQUIPMENT OF A STRIP

(71) Applicant: ArcelorMittal, Luxembourg (LU)

(72) Inventors: Akshay BANSAL, Maizières-Lès-Metz (FR); Gérard GRIFFAY, Coincy (FR); Vladislav JANECEK, Ravensburg (DE)

(21) Appl. No.: 17/612,788

(22) PCT Filed: Apr. 17, 2020
(86) PCT No.: PCT/IB2020/053659

§ 371 Date: Nov. 19, 2021

(30) Foreign Application Priority Data
May 23, 2019 (IB) PCT/IB2019/054265

(51) Int. Cl. G01N 1/22; G01N 1/02; G01N 19/10

(52) U.S. Cl. CPC G01N 1/2247; G01N 2001/028; G01N 19/10; G01N 1/02

(57) ABSTRACT

A method for detecting the presence of humidity on a surface of a flat strip, in particular a bare metal strip or of a coated metal strip having the following steps: blowing on the surface an impinging air flow producing an air flow deflected by the surface, the impinging air flow not being saturated, measuring a humidity content of at least a portion of the deflected air flow, comparing the humidity content of the impinging air flow and the deflected air flow, if said humidity content of the deflected air flow is superior to the humidity content of the impinging air flow, the presence of humidity on the surface of the bare metal strip or of the coated metal strip is detected.

### BACKGROUND

The present invention relates to a method and an equipment permitting to detect the presence of humidity on a surface of a strip, in particular a bare or coated metal strip.

### SUMMARY OF THE INVENTION

For example, in the metallurgy, the metallic products, such as a washed, rinsed coated metallic strip, might be moist or humid. Humidity in its outer layer is often present after process steps involving liquid, such as water cooling. The presence of humidity might lead to the degradation of the coating on a metallic strip and/or lower the properties of a bare metallic strip, in both cases the product is usually downgraded. In the case of the coated strip, the product degradation can occur during the convey of the strip and can be produced by the transport rolls leaving marks on said coating. Consequently, detecting the presence of humidity on a surface of a metal strip is important to ensure a good quality of the product and permits to control some process steps such as the strip drying.

It is an object of the present invention to provide a solution permitting detection of the presence of humidity on a surface of a strip, in particular a bare or coated metal strip.

The present invention provides a method for detecting the presence of humidity on a surface (2) of a bare metal strip (3) or of a coated metal strip (3) comprising the following steps:
blowing on said surface an impinging air flow (1) producing an air flow deflected (4) by said surface (3), said impinging air flow (1) not being saturated,
measuring a humidity content of at least a portion of said deflected air flow (4),
comparing the humidity content of said impinging air flow (1) and said deflected air flow (4).
if said humidity content of said deflected air flow (4) is superior to said humidity content of said impinging air flow (1), the presence of humidity on said surface of said bare metal strip (3) or of said coated metal strip (3) is detected.

The present invention also provides an equipment for detecting the presence of humidity on a surface of a metal strip (3) or of a coated metal strip (3) comprising:
a hollow body (6h) comprising a double wall (7) and a central portion (8) and said double wall and central part comprising at least one opening (9) facing said surface (2) of a metal strip or of a coated metal strip (3),
at least a means to blow a gas into the double wall (7) and configured so that said blown gas exits said double wall (7) by said at least one opening facing said surface (9),
at least the humidity measuring means (5) encompassed by said hollow body (6h) and outside of said double wall (7),
said at least one opening facing (9) said surface (2) of a metal strip or of a coated metal strip (3) is configured to create a continuous blown gas curtain (12) between said hollow body (6h) and said surface (2) of a metal strip or of a coated metal strip (3) and to deflect at least a portion of said blown gas onto the surface of a metal strip or of a coated metal strip towards at least one of said absolute humidity measuring means (5).

Other characteristics and advantages of the invention will become apparent from the following detailed description of the invention.

### BRIEF DESCRIPTION OF THE DRAWINGS

To illustrate the invention, various embodiment and trials of non-limiting example will be described, particularly with reference to the following figures:

FIG. 1 exhibits the air flows during the use of an embodiment of the present invention.

FIG. 2 exhibits an embodiment of the present invention.

FIG. 3 exhibits an embodiment of the present invention.

FIG. 4 represents a wiping phenomenon of an impinging air flow.

FIG. 5 represents a border deflection phenomenon of an impinging air flow.

FIG. 6 represents various streamline contours in function of two process parameters.

FIG. 7 represents a gas curtain during the use of an embodiment of the present invention.

FIG. 8 exhibits an embodiment of the present invention comprising air guiding means.

FIG. 9 exhibits two numerical models of the velocity vectors of the impinging gas.

### DETAILED DESCRIPTION

The invention relates to a method for detecting the presence of humidity on a surface of a bare metal strip or of a coated metal strip comprising the following steps:

A—blowing on said surface an impinging air flow producing an air flow deflected by said surface, said impinging air flow not being saturated,

B—measuring a humidity content of at least a portion of said deflected air flow,

C—comparing the humidity content of said impinging air flow and said deflected air flow,

D—if said humidity content of said deflected air flow is superior to said humidity content of said impinging air flow, the presence of humidity on said surface of said bare metal strip or of said coated metal strip is detected.

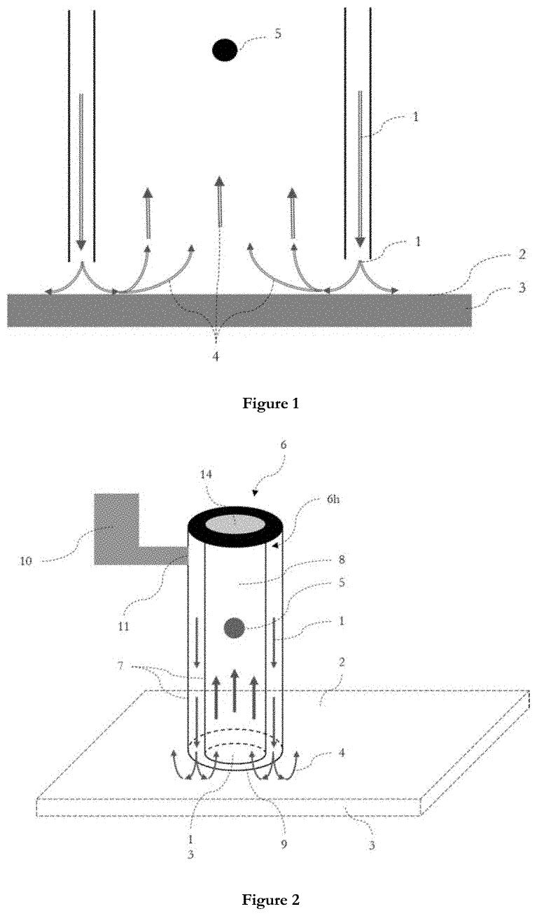

In the first step, as illustrated in FIG. 1, an impinging air flow 1 is blown on a surface 2 of a bare or coated metal strip 3 and produces an air flow deflected 4. Said impinging air flow 1 is not saturated so the impinging air flow can absorb more water. When said surface is humid, the impinging air flow 1 reaching the metal strip surface 2 picks up at least a portion of the humidity presents on said surface.

The humidity pick up depends on numerous factors. An impinging air can absorb humidity from said surface only if some humid layer is present on the said surface and if said impinging air is not saturated with humidity. Moreover, the smaller is the humidity content of the impinging air, the better the air can absorb humidity. Without willing to be bound by any theory, apparently, the higher is the impinging air temperature, the more it the air can absorb humidity. Apparently, that is why the skilled person in the art could adjust a humidity content and the temperature of the impinging air flow 1 as a in function of the humidity threshold that is detected/aimed to be detected.

In the second step, the humidity content of at least a portion of said deflected air flow 4 is measured. The measurement is preferably done in a way that the measured humidity content of said deflected air flow 4 is close to the humidity content of said deflected air flow right after it contacted said surface. In other words, the deflected air flow 4 should not exchange any humidity content between its deflection from the surface until its humidity content is measured. It is also preferable that only said deflected air flow 4 is measured by the humidity measurement means 5. If it is not the case, the measurement might be skewed.

In the third step, the humidity content of said impinging air flow 1 is compared to the measured humidity content of said deflected air flow 4.

In the fourth step, the presence or absence of humidity on a surface can be established. If the humidity content of said deflected air flow 4 is higher than of said impinging air flow 1, then humidity is present on the strip surface 2. Only the presence of humidity can be established because this assessment method has a lower threshold. The lower threshold corresponds to the minimum humidity content that can be detected by this method and the equipment associated. As previously explained, it depends on several factors known by the skilled person in the art.

Consequently, the invention permits to qualitatively detect the presence of humidity on a surface of a bare or coated metal strip.

Preferably, said impinging air flow 1 has a controlled humidity content of less than 10 000 ppm of water. More preferably, said impinging air flow has a controlled humidity content of less than 8 000 ppm of water. Even more preferably, said impinging air flow has a controlled humidity content of less than 4 000 ppm of water.

Preferably, said impinging air flow 1 has a speed comprised between 20 and 60 m·s⁻¹. Such an air flow speed permits to have an optimal impinging air flow. If the air flow speed is lower than 20 m·s⁻¹, the air flow hardly touches the surface, as illustrated in FIG. 5. If the air flow speed is higher than 60 m·s⁻¹, the impinging air flow 1 can be subject to the wiping phenomenon, i.e. the impinging air flow 1 will be deflected by the tip of its canal, as illustrated in FIG. 4. Moreover, if the impinging air flow is too high, the jet does not have enough time to develop under shear from air and hit the strip and create the required fountain effect. Thus, the humidity absorption is more efficient when the air flow speed is comprised between 20 and 60 m·s⁻¹. More preferably, said impinging air flow has a speed comprised between 30 and 50 m·s⁻¹

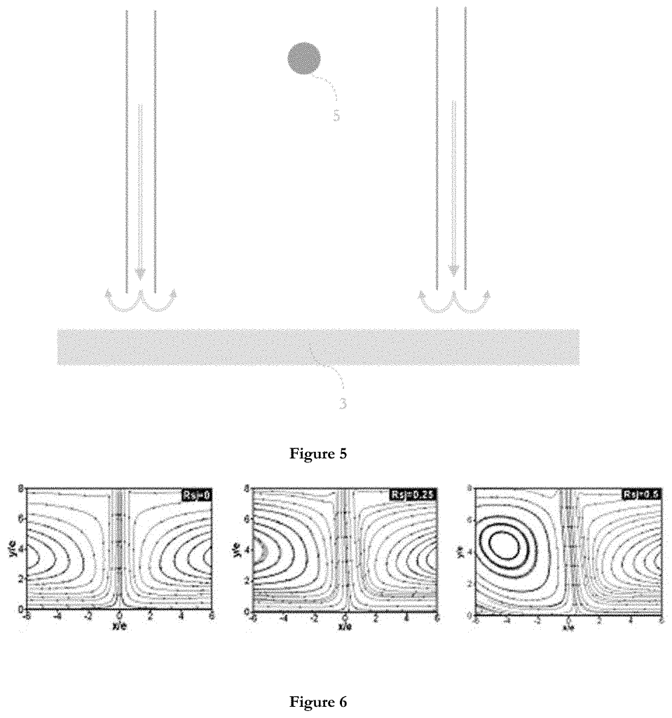

Preferably, said bare metal or coated metal 3 is continuously moved at a determined speed and said impinging air flow 1 has a speed of at least two times said metal speed. Such a range permits to increase the humidity absorption of said impinging air flow because it prevents jet sweeping due to the movement of the strip. When the impinging air flow 1 speed is not at least equal to 0.25 time the one of said bare or coated metal, the impinging air flow 1 absorption of the humidity on said surface is not optimal. In FIG. 6 are plotted several streamline contours illustrating the impinging air flow on the metallic surface in function of the metallic strip speed, V_{STRIP}, and the impinging air flow speed V_{JET}. The streamline emerging from the top of the figure and comprised between −0.5 and 0.5 on the “x/e” axe represents the impinging air flow while the metal strip surface is represented along the “y/c”=0 line. R_{SJ}=V_{STRIP}/V_{JET}. It is noticeable that for a R_{SJ} of 0 and 0.25, the impinging air flow contacts the strip surface and without creating turbulence whereas, for a Rsj of 0.5, turbulence starts to appear. Thus, the humidity absorption is more efficient when said impinging air flow has a speed of at least two times said metal speed. For example, the speed of the impinging air flow is of 40 m·s⁻¹ and the strip speed is below 20 m·s⁻¹.

More preferably, said bare metal or coated metal 3 is continuously moved at a determined speed and said impinging air flow 1 has a speed of at least four times said metal speed.

Preferably, said impinging air flow 1 is produced by an air blowing means 6, said impinging air flow exits said air blowing means at a speed Vi and said air blowing means is positioned at a distance D from said metal strip such that: 1·10⁻⁴ s⁻¹<D/Vi<5·10⁻³ s⁻¹. Apparently, higher is the distance at which said air blowing means is positioned from said metal strip, higher should be the impinging air flow speed in order to ensure the air deflection. For example, the impinging air flow speed can be of 50 m·s⁻¹ and the distance D is of 20 mm. Of course, the minimum distance at which the air blowing means is limited by the strip vibration, i.e. the strip should not contact the air blowing means.

Preferably, said impinging air flow 1 is produced by an air blower, said blower is moved across the strip width. It permits to detect default across the strip width. Moreover, several air blowers can be used to detect the presence of humidity at several spots across the strip width and length.

The invention also relates to an equipment for detecting the presence of humidity on a surface of a metal strip 3 or of a coated metal strip 3 comprising:
a hollow body 6h comprising a double wall 7 and a central portion 8 and said double wall and central part comprising at least one opening 9 facing said surface 2 of a metal strip or of a coated metal strip 3,
at least a means to blow a gas into the double wall 7 and configured so that said blown gas exits said double wall 7 by said at least one opening facing said surface 9,
at least the humidity measuring means 5 encompassed by said hollow body 6h and outside of said double wall 7,
said at least one opening facing 9 said surface 2 of a metal strip or of a coated metal strip 3 is configured to create a continuous blown gas curtain 12 between said hollow body 6h and said surface 2 of a metal strip or of a coated metal strip 3 and to deflect at least a portion of said blown gas onto the surface of a metal strip or of a coated metal strip towards at least one of said absolute humidity measuring means 5.

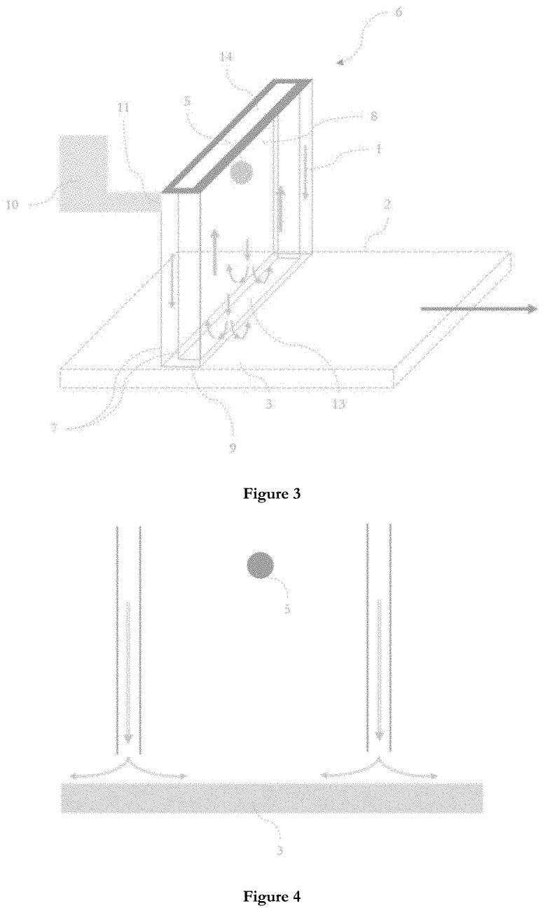

As illustrated in FIGS. 2 and 3, said equipment comprises a double wall 7 wherein a gas can freely flow around said central portion 8. A gas is blown into the double wall 7 by a blowing gas means 10 and exits said double wall 7 by at least one opening facing the metal strip surface 9. As the invention aims to blow a gas onto said surface 9, the entry 11 of the blown gas into the double wall 7 is preferably configured such that the exit of the gas through the opening 9 is eased. In other words, from the blown gas entrance into the double wall until its exit, the blowing gas should always flow towards said opening 9. This principle aims at reducing turbulence in the double wall and thus having a more uniform flow profile at the slot exit. Preferably, the blown gas has a pressure above the atmospheric pressure leading to a natural exit through the opening 9. The function of the central part 8 of the hollow body 6 is to isolate the humidity content measuring device from the ambient air so that it only measures the humidity content of the deflected air flow 4 towards the measuring means 5.

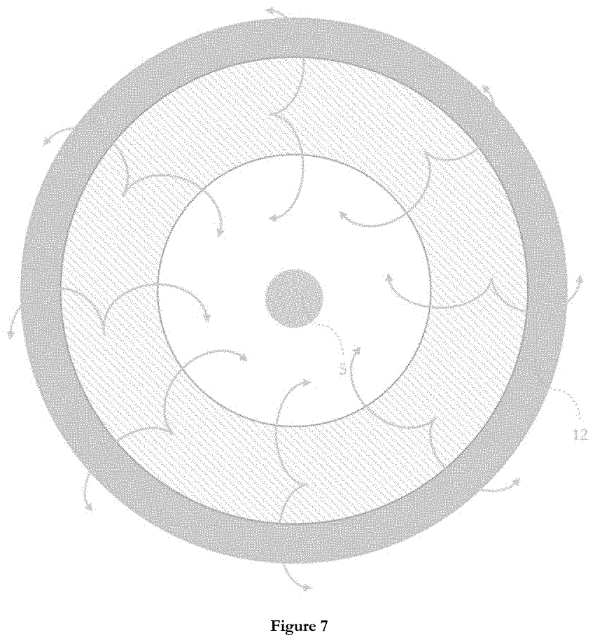

As illustrated in FIG. 7, said at least one opening is configured to create a continuous gas curtain 12 between said hollow body 6 and said surface 2. This gas curtain is made by the blown gas. Only a portion of the deflected gas enters the central part 8 of the hollow body 6 for two reasons. Firstly, such a continuous gas curtain prevents the ambient air to enter said central part 8 from its surface side. The gas is preventing from entering by the other side 14 of the central part 8 due to the pressure difference between the deflected gas 4 and the atmospheric pressure. Because the deflected gas has a higher pressure, it is naturally dragged through the central part 8 from the strip surface side to the other side. Thus, non-deflected air is prevented from entering in said central part 8.

As illustrated in FIGS. 2 and 3, said central part 8 comprises at least a humidity content measuring means 5. Thanks to the previously explained phenomenon, only the humidity content of the deflected air 4 is measured by said measuring means or humidity sensor 5 because only the deflected air comes into contact with the humidity content measuring means 5.

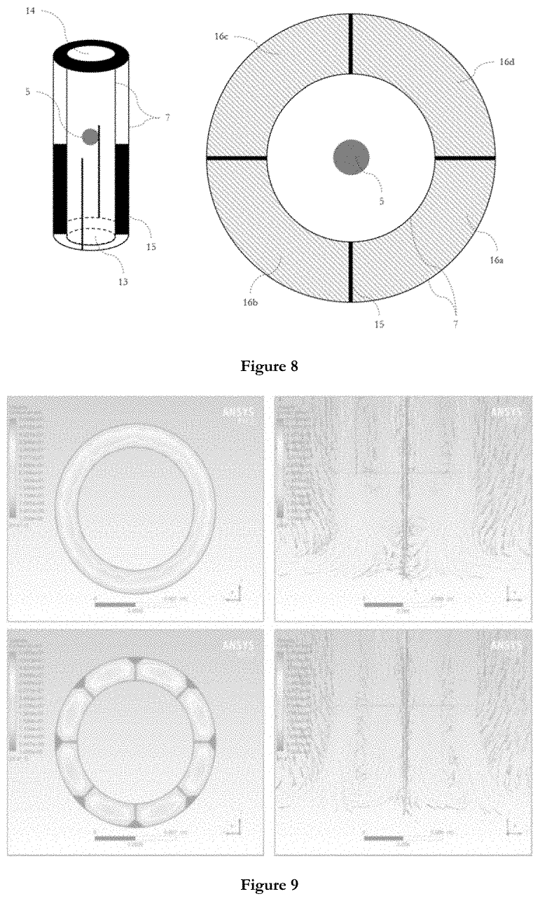

Preferably, as illustrated in FIG. 8, said equipment comprises one opening facing said surface of a metal strip or of a coated metal strip, said opening being segmented into two to twenty parts.

Preferably, said equipment comprises one opening 9 facing said surface of a metal strip or of a coated metal strip, said opening 9 being segmented (16a, 16b, 16c, 16d) into four to ten compartments.

Preferably, said double wall 7 comprises gas guiding means 15 configured to guide said blown gas perpendicularly to said surface of a metal strip or of a coated metal strip from inside said hollow body 6h to said at least four to ten compartments (16a, 16b, 16c, 16d). As illustrated in FIG. 8, guiding means 15 such as fins are placed inside the double wall 7. They extend from said one opening 9 facing said surface 2 to somewhere in the double wall. Preferably, said guiding means extend preferentially from said compartmented opening to half the height of the double wall creating compartments (16a, 16b, 16c and 16d), as represented in FIG. 7. They aim to create an exiting impinging flow perpendicular to the surface 2 by reducing and/or suppressing any radial component of the blown flow 1. The longer the gas guiding means, the more the impinging air flow speed is decreased due to head loss. Gas guiding means 15 are used to increase the proportion of reflected gas flow and the effectiveness of the gas curtain 12. FIG. 9 exhibits two numerical models of the velocity vectors of the impinging gas 1 after they exit one opening 9 facing said surface 2. In the first case, no fins have been placed while in the second case, 8 fins have been placed. It can be observed in the second case that a greater portion of the impinging flow has been deflected inside said central part 8 which improves the humidity content measurement because it increases the humidity content absorbed and flown inside said central part 8.

Preferably, said hollow body 6h is made of a material having a rugosity smaller than 2 mm. Without willing to be bound by any theory, if the rugosity is higher than 2 mm, the impinging jet is deflected sidewise reducing the portion of the deflected air on said surface 2 as illustrated in FIG. 2. More preferably, said hollow body is made of a material having a rugosity smaller than 1 mm. Even more preferably, said hollow body is made of a material having a rugosity smaller than 500 μm.

Preferably, said hollow body 6h is made of a water-repellent material. Such a material permits reduction of the humidity absorption by the hollow body which improves the reliability of the measured humidity content of the deflected gas 4 because a smaller humidity content is transferred from the deflected gas 4 to the hollow body 6 or vice-versa.

Preferably, said equipment comprises means to convey said metal strip 3. Conveying the metal strip enables to have several measurement points of the humidity content along the strip. The strip convey can be achieved through rolls.

Preferably, said hollow body is a hollow cylinder having an inner radius, an outer radius and a length. As illustrated in FIG. 6, using a hollow cylinder is advantageous because the curtain is more efficient because it is homogeneous around said central part 8. Moreover, the air circulation inside the hollow body is improved because there is no edge.

Preferably, said hollow cylinder length is perpendicular to said strip surface. It is advantageous because the curtain is more efficient because it is homogeneous around said central part 8.

What is claimed is:

1-15. (canceled)

16. A method for detecting a presence of humidity on a surface of a bare metal strip or of a coated metal strip, the method comprising the following steps:
blowing an impinging air flow on the surface to produce a deflected air flow deflected by the surface, the impinging air flow not being saturated;
measuring a humidity content of at least a portion of the deflected air flow;
comparing an impinging air flow humidity content and the humidity content of the deflected air flow; and
if the humidity content of said deflected air flow is superior to the impinging air flow humidity content, detecting the presence of humidity on the surface of the bare metal strip or of the coated metal strip.

17. The method as recited in claim 16 wherein the impinging air flow has a controlled humidity content of less than 10 000 ppm of water.

18. The method as recited in claim 16 wherein the impinging air flow has a speed comprised between 20 and 60 m·s⁻¹.

19. The method as recited in claim 16 wherein the metal or coated metal strip is continuously moved at a determined speed and the impinging air flow has a speed at least two times the metal speed.

20. The method as recited in claim 19 wherein the metal or coated metal strip is continuously moved at a determined speed and the impinging air flow has a speed at least four times the metal speed.

21. The method as recited in claim 16 wherein the impinging air flow is produced by an air blower, the impinging air flow exiting the air blower at a speed Vi and the air blower is positioned at a distance D from the metal strip such that:
1·10⁻⁴ s⁻¹<D/Vi<5·10⁻³ s⁻¹.

22. The method as recited in claim 16 wherein the impinging air flow is produced by an air blower moved across a strip width.

23. An equipment for detecting a presence of humidity on a surface of a metal strip or of a coated metal strip, the equipment comprising:
a hollow body including a double wall and a central portion, the double wall and central portion comprising at least one opening facing the surface of a metal strip or of a coated metal strip;
a gas blower for blowing a gas into the double wall and configured so that the blown gas exits the double wall by the at least one opening facing the surface;
at least one humidity sensor encompassed by the hollow body and outside of the double wall;
the at least one opening being configured to create a continuous blown gas curtain between the hollow body and the surface of the metal strip or of the coated metal strip and to deflect at least a portion of the blown gas onto the surface of the metal strip or of the coated metal strip towards the at least one humidity sensor.

24. The equipment as recited in claim 23 wherein the at least one opening is one opening segmented into four to ten compartments.

25. The equipment as recited in claim 24 wherein the double wall includes gas guides configured to guide the blown gas perpendicularly to the surface of the metal strip or of the coated metal strip from inside the hollow body to the four to ten compartments.

26. The equipment as recited in claim 23 wherein the hollow body is made of a material having a rugosity smaller than 2 mm.

27. The equipment as recited in claim 23 wherein the hollow body is made of a water-repellent material.

28. The equipment as recited in claim 23 further comprising a conveyor to convey the metal or coated metal strip.

29. The equipment as recited in claim 23 wherein the hollow body is a hollow cylinder having an inner radius, an outer radius and a length.

30. The equipment as recited in claim 29 wherein the hollow cylinder length is perpendicular to the surface of the metal or coated metal strip.
